(19) United States
(12) Patent Application Publication
(10) Pub. No.: US 2024/0375450 A1
(43) Pub. Date: Nov. 14, 2024

(54) PNEUMATIC TIRE

(71) Applicant: BRIDGESTONE CORPORATION, Chuo-ku, Tokyo (JP)

(72) Inventors: Hiroyuki MATSUMOTO, Chuo-ku, Tokyo (JP); Yoshio KAJI, Chuo-ku, Tokyo (JP); Hiroshi NOMURA, Chuo-ku, Tokyo (JP)

(73) Assignee: BRIDGESTONE CORPORATION, Chuo-ku, Tokyo (JP)

(21) Appl. No.: 18/692,827

(22) PCT Filed: May 6, 2022
(86) PCT No.: PCT/JP2022/019599

§ 371 Date: Mar. 18, 2024

(30) Foreign Application Priority Data
Oct. 28, 2021 (JP) 2021-176992

(51) Int. Cl. B60C 11/12

(52) U.S. Cl. CPC B60C 11/1236; B60C 11/1204; B60C 2011/1213; B60C 2011/1254

(57) ABSTRACT

The provided is a pneumatic tire having at least one land portion in a tread surface, wherein one or more connected sipes are disposed on at least one of the land portions, the connected sipes have a main portion extending in a first predetermined direction and a side portion extending from the main portion to a side of the main portion at an angle with respect to the first predetermined direction, the side portion has a first side portion disposed on one side of the main portion and a second side portion disposed on the other side of the main portion, and the first side portion and the second side portion are arranged alternately in the tire circumferential direction.

### TECHNICAL FIELD

This disclosure is related to a pneumatic tire.

### BACKGROUND

Conventionally, the land portion of the tread portion of pneumatic tires, especially of studless tires, has been provided with narrow grooves called sipes to improve on-ice gripping performance. The sipes allow water that gushes onto the tire contact patch as the icy road surface melts to drain out of the contact patch, thereby improving on-ice gripping performance.

The prior art that improves on-ice gripping performance by disposing sipes at a high density while minimizing the reduction in rigidity of the land portion, has been proposed (For example, Patent Document 1).

### CITATION LIST

### Patent Literature

PTL 1: JP 2005-186827 A1

### SUMMARY

### Technical Problem

However, the art in Patent Document 1 was not sufficient to balance the rigidity of the land portion and the water drainage by the sipes, and there was room for improvement in improving on-ice gripping performance.

It is therefore an object of the present disclosure to provide a pneumatic tire with improved on-ice gripping performance.

### Solution to Problem

The gist structure of the invention is as follows.

(1) A pneumatic tire having at least one land portion in a tread surface, wherein
one or more connected sipes are disposed on at least one of the land portions,
the connected sipes have a main portion extending in a first predetermined direction and a side portion extending from the main portion to a side of the main portion at an angle with respect to the first predetermined direction,
the side portion has a first side portion disposed on one side of the main portion and a second side portion disposed on the other side of the main portion, and
the first side portion and the second side portion are arranged alternately in the tire circumferential direction.

Here, the “tread surface” refers to the outer circumferential surface of the pneumatic tire that is in contact with the road surface when the pneumatic tire is assembled on an applicable rim, filled with prescribed internal pressure, and rolled under a maximum load. In addition, the “sipe” in the “connected sipe” means the one whose sipe width is 1 mm or less in the area of 50% or more of the sipe depth when the tire is assembled on the applicable rim, filled with the prescribed internal pressure, and unloaded. Here, the sipe depth is measured perpendicular to the tread surface in the above condition, and the sipe width is measured parallel to the tread surface in a cross section perpendicular to the extending direction of the sipe on the tread surface.

As used herein, the “applicable rim” refers to the standard rim in the applicable size (Measuring Rim in ETRTO's STANDARDS MANUAL and Design Rim in TRA's YEAR BOOK) as described or as may be described in the future in the industrial standard, which is valid for the region in which the tire is produced and used, such as JATMA YEAR BOOK of JATMA (Japan Automobile Tyre Manufacturers Association) in Japan, STANDARDS MANUAL of ETRTO (The European Tyre and Rim Technical Organization) in Europe, and YEAR BOOK of TRA (The Tire and Rim Association, Inc.) in the United States (That is, the “rim” above includes current sizes as well as future sizes to be listed in the aforementioned industrial standards. An example of the “size as described in the future” could be the sizes listed as “FUTURE DEVELOPMENTS” in the ETRTO 2013 edition). For sizes not listed in these industrial standards, the “applicable rim” refers to a rim with a width corresponding to the bead width of the tire. In addition, the “prescribed internal pressure” refers to the air pressure (maximum air pressure) corresponding to the maximum load capacity of a single wheel in the applicable size and ply rating, as described in the aforementioned JATMA, and others. In the case that the size is not listed in the aforementioned industrial standards, the “prescribed internal pressure” refers to the air pressure (maximum air pressure) corresponding to the maximum load capacity specified for each vehicle in which the tire is mounted. Further, the “maximum load” refers to the load corresponding to the above maximum load capacity.

### Advantageous Effect

According to the present disclosure, it is possible to provide a pneumatic tire with improved on-ice gripping performance.

### BRIEF DESCRIPTION OF THE DRAWINGS

In the accompanying drawings:

FIG. 1 illustrates the tread pattern of a pneumatic tire according to one embodiment of this disclosure;

FIG. 2 is a plan view illustrating the configuration of the connected sipe;

FIG. 3 illustrates the dimensions of the connected sipes;

FIG. 4 is a table providing Examples and Comparative Examples.

FIG. 5 provides the relationship between block rigidity and actual footprint area under shear; and

FIG. 6 provides the relationship between edge density and actual footprint area.

### DETAILED DESCRIPTION

The following is a detailed illustration of the embodiment of this disclosure with reference to the drawings.

First, the internal structure, etc. of the pneumatic tire (hereinafter referred to simply as “tire”) can be the same as that of a conventional tire. As an example, the tire may have a pair of bead portions, a pair of sidewall portions connected to the pair of bead portions, and a tread portion disposed between the pair of sidewall portions. Also, the tire may have a carcass straddling toroidally between the pair of bead portions, and a belt disposed on the outer side in the tire radial direction of the crown portion of the carcass.

Hereafter, unless otherwise noted, dimensions, etc. refer to those when the tire is mounted on the applicable rim, filled to the prescribed internal pressure, and unloaded.

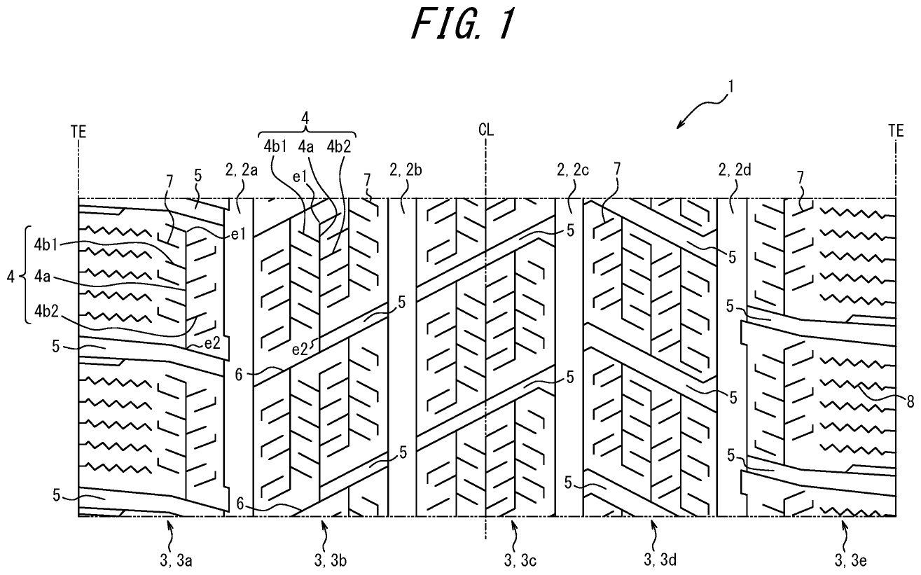

FIG. 1 illustrates the tread pattern of the pneumatic tire according to one embodiment of this disclosure. As illustrated in FIG. 1, the tire has one or more (four in the illustrated example) circumferential main grooves 2 (2a to 2d) extending in the tire circumferential direction on the tread surface 1. The number of the circumferential main grooves 2 is not limited to this example and can be changed as needed.

The width (opening width) of the circumferential main groove 2 is not particularly limited, but can be 4 to 15 mm, for example, and the depth (maximum depth) of the circumferential main groove 2 is not particularly limited, but can be 6 to 20 mm, for example. In the illustrated example, the circumferential main groove 2 extends straightly in the tire circumferential direction, but it can also extend in a zigzag or flexing manner. The circumferential main groove 2 may be inclined at an angle of 5° or less with respect to the tire circumferential direction.

As illustrated in FIG. 1, the circumferential main grooves 2 and the tread edges TE form a plurality (five in the illustrated example) of land portions 3 (3a to 3e). That is, the land portion 3a is formed by the tread edge TE and the circumferential main groove 2a, the land portion 3b is formed between the circumferential main grooves 2a and 2b, the land portion 3c is formed between the circumferential main grooves 2b and 2c, the land portion 3d is formed between the circumferential main grooves 2c and 2d, and the land portion 3e is formed by the tread edge TE and the circumferential main groove 2d. Thus, the tire has at least one land portion 3.

A plurality of width direction grooves 5 extending in the tire width direction are arranged at intervals in the tire circumferential direction on each of the land portions 3a to 3e. In the land portions 3a, 3c, 3d, and 3e, the width direction grooves 5 are connected to two adjacent circumferential main grooves 2, thus the land portions 3a, 3c, 3d, and 3e are divided into blocks. On the other hand, in the land portion 3b, the width direction grooves 5 are connected to the circumferential main groove 2b at one end and terminates within land portion 3b at the other end, thus the land portion 3b is a rib-shaped land portion (a land portion not completely divided circumferentially by the width direction grooves 5). The other end of the width direction groove 5A is connected to a width direction sipe 6 extending in the tire width direction, and the width direction sipe 6 extends from the other end of the width direction groove 5 and is connected to the circumferential main groove 2a.

The width of the width direction groove 5 (the opening width, or the maximum width if the groove width varies) is not particularly limited, but can be 2 to 10 mm, for example. The depth (maximum depth) of the width direction groove 5 is not limited, but can be 5 to 20 mm, for example. Furthermore, the width direction groove 5 preferably extends in the tire width direction or be inclined at an angle of more than 0° and 45° or less with respect to the tire width direction. The width direction grooves 5 can be arranged at equal intervals in the tire circumferential direction, or may be arranged with various pitch intervals in order to reduce pattern noise.

The sipe width (the opening width) of the width direction sipe 6 is not particularly limited, but can be 0.3 to 1 mm. The sipe depth (maximum depth) of the width direction sipe 6 is not limited, but can be 3 to 10 mm, for example. Furthermore, the width direction sipe 6 preferably extends in the tire width direction or be inclined at an angle of more than 0° and 45° or less with respect to the tire width direction.

Note, that the land portions 3a and 3e are provided with a plurality of width direction sipes 8 extending from the tread edge TE and terminating in the land portions at approximately equal intervals in the tire circumferential direction.

Here, in this tire, one or more connected sipes 4 are disposed on at least one (in this example, all of the land portions 3) of the land portions 3. In the illustrated example, one or more connected sipes 4 are disposed in each block defined by the width direction grooves 5 (or in each portion defined by the width direction groove 5 and the width direction sipe 6).

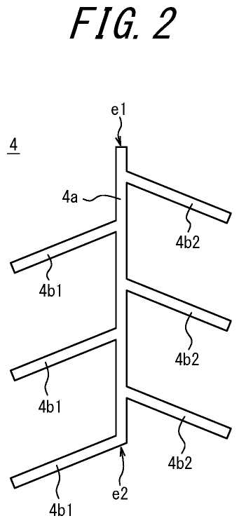

FIG. 2 is a plan view of the connected sipe 4. As illustrated in FIGS. 1 and 2, the connected sipe 4 has a main portion 4a extending in a first predetermined direction (the tire circumferential direction in the illustrated example) and a side portion 4b1, 4b2 extending from the main portion 4a to the side of the main portion 4a at an angle with respect to the first predetermined direction (to the tire circumferential direction in the illustrated example), thus the connected sipe 4 is a branch-like sipe consisting of these connected together. The connected sipe 4 is a branch-shaped sipe, comprising these connected together. The main portion 4a and the side portion 4b1, 4b2 are sipe portions. The side portion has a first side portion 4b1 disposed on one side of the main portion 4a and a second side portion 4b2 disposed on the other side of the main portion 4a, and the first side portion 4b1 and the second side portion 4b2 are arranged alternately in the tire circumferential direction. In the illustrated example, the first side portion 4b1 extends to one side in the tire width direction (left side in the figure) and terminates in the land portion 3, and the second side portion 4b2 extends to the other side in the tire width direction (right side in the figure) and terminates in the land portion 3.

The main portion 4al extends in the tire circumferential direction in the illustrated example, but may extend at an inclination angle of 15° or less with respect to the tire circumferential direction. In addition, in the illustrated example, the land portions 3a, 3c, 3d, and 3e are block-shaped land portions, and the land portion 3b is defined by the width directional sipe 6, although it is a rib-shaped land portion. Thus, the extending length of the main portion 4a is shorter than the circumferential length of the block (or the block-shaped portion defined by the width direction sipe 6). Furthermore, at least one end of the main portion 4a terminates within the land portion 3. In the illustrated example, only one end e1 of the main portion 3a in the first predetermined direction (in the tire circumferential direction in this example) terminates in the land portion 3, while the other end e2 is connected to the width direction groove 5 or the width direction sipe 6. On the other hand, when the land portion 3 is a rib-shaped land portion, the main portion 4a may also extend continuously for one round in the tire circumferential direction.

The side portion 4b1, 4b2 can extend at an inclination angle of, for example, 45 to 90° with respect to the first predetermined direction, which is the extending direction of the main portion 4a, although this is not particularly limited. Typically, the side portion 4b1, 4b2 extends in the tire width direction or at an angle with respect to the tire width direction (e.g., the inclination angle can be 45° or less with respect to the tire width direction). In the illustrated example, both of the side portions 4b1 and 4b2 extend toward one side of the extending direction of the main portion 4a (one side in the tire circumferential direction), but the first side portion 4b1 and the second side portion 4b2 may extend on opposite sides of the extending direction of the main portion 4a from each other (in this case, the side portion 4b1 may extend to one side or the other side).

Here, when the length in the tire width direction (when projected in the tire width direction) of the connected sipe 4 is w1 (mm) and the depth (maximum depth) of the micro sipes (4a, 4b1, 4b2) comprising the connected sipe is h (mm), w1×h is preferably 150 (mm²) or less. This is because by making the connected sipes 4 smaller, the connected sipes 4 can be densely arranged to further improve on-ice performance. For the same reason, it is more preferable that w1×h be 100 (mm²) or less and even more preferable that it be 50 (mm²) or less.

In addition, when the number of connected sipes 4 in the land portion 3 is n, the maximum width of the land portion 3 in the tire width direction is BW (mm), the “equivalent length of the land portion in the tire circumferential direction” obtained by dividing the outer contour area (the area enclosed by the outer contour) (mm²) of the land portion 3 by BW (mm) is BL (mm), the equivalent number of sipes N (the number of sipes converted to transverse sipes provided completely across the land portion) is defined as w1×n/BW, the average sipe spacing in the tire circumferential direction is expressed as BL/(N+1), and the sipe density SD is defined as the inverse of the average sipe spacing in the tire circumferential direction, and it is expressed as SD=(N+1)/BL=((w1×n/BW)+1)/BL, SD is preferably 0.15 (1/mm) or more. This is because the high density of the connected sipes can further improve on-ice performance. For the same reason, the sipe density SD of 0.20 (1/mm) or more is more preferable, and 0.30 (1/mm) or more is even more preferable.

Note, that the number of connected sipes n, the maximum width of the land portion in the tire width direction BW, and the outer contour area of the land portion are the values measured in the expanded view of the tread portion. The “outer contour area” refers to the area enclosed by the outer contour in the expanded view of the tread portion, and therefore, even if non-ground portions such as sipes, small holes, narrow grooves, etc. are disposed within the land portion, the area does not exclude the area of the sipes, small holes, narrow grooves, etc.

The following is a description of the effects of this pneumatic tire.

In the pneumatic tire of this embodiment, first, one or more connected sipes 4 are disposed on at least one of the land portions 3, and the connected sipes 4 have a main portion 4a extending in the first predetermined direction and the side portion 4b1, 4b2 extending from the main portion 4a to the side of the main portion 4b at an angle with respect to the first predetermined direction. Therefore, while these sipe portions cut the water film, water can be discharged in the first predetermined direction (the tire circumferential direction in this example) by the main portion 4a, and water can also be discharged to the side by the side portions 4b1 and 4b2 connected to the main portion 4a, thus enabling efficient water film removal. In addition, the side portion has the first side portion 4b1 disposed on one side of the main portion 4a and a second side portion 4b2 disposed on the other side of the main portion 4a, and the first side portion 4b1 and the second side portion 4b2 are arranged alternately in the tire circumferential direction. Therefore, these side portions can be densely arranged, further increasing the effectiveness of the above water film removal.

On the other hand, since the side portions 4b1 and 4b2 terminate within the land portion 3, the reduction in the rigidity of the land portion 3 can be controlled compared to the case where the block is completely divided in the tire circumferential direction to form a block piece by a width direction sipe extending between two circumferential main grooves, for example.

As described above, the pneumatic tire of this embodiment can effectively remove water film while preventing a reduction in the rigidity of the land portion 3, thereby improving on-ice gripping performance.

In particular, in this embodiment, at least one end e1 of the main portion 4a terminates within the land portion 3, which further prevents the reduction in the rigidity of the land portion 3 and further improves the on-ice gripping performance. From the viewpoint of preventing the reducing in the rigidity of the land portion 3, it is preferable that both ends of the main portion 4a terminate within the land portion 3, but from the viewpoint of effectively removing water film, the other end 4e or both ends may be connected to a width direction groove or a width direction sipe. In this example, one end terminates within the land portion 3 and the other end is connected to the width direction groove 5 or the width direction sipe 6, thus ensuring rigidity of the land portion at one end while providing effective water film removal at the other end.

Furthermore, if w1×h is in the above range, the connected sipes can be disposed more densely, which can further improve on-ice gripping performance. In addition, if the sipe density SD is within the above range, the connected sipes will be densely arranged, which will improve the effectiveness of water film removal and further enhance on-ice gripping performance.

Moreover, in this embodiment, the main portion 4a extends in the tire circumferential direction, and the side portions 4b1 and 4b2 extend in the tire width direction or at an angle with respect to the tire width direction as in this example. This allows the main portion 4a to have an edge component in the tire circumferential direction (edge component relative to the tire width direction), which improves the lateral gripping performance during cornering. In addition, the side portions 4b1 and 4b2 provide an edge component in the tire width direction (edge component relative to the tire circumferential direction), which improves on-ice traction performance and on-ice braking performance in straight running.

As illustrated in FIG. 1, the tire of this embodiment has land portions 3b, 3c, and 3d, in which a plurality of rows of connected sipes 4 (in the illustrated example, a plurality of connected sipes 4 are arranged at intervals in the tire circumferential direction to form one row) are arranged in the second predetermined direction (in this example, the tire width direction). First, this will increase the effectiveness of water film removal compared to disposing only one row of connected sipes 4 on each land portion 3. Note, that when the main portion 4 extends continuously for one round in the tire circumferential direction, one connected sipe forms one row. In addition, the second predetermined direction may be inclined with respect to the tire width direction, and the inclination angle with respect to the tire width direction may be more than 0° and 30° or less, for example.

In addition, as illustrated in FIG. 1, two rows adjacent to each other in the second predetermined direction are arranged phase-shifted in the tire circumferential direction, such that the side portion (4bl or 4b2) of the connected sipe 4 of one row and the side portion (4b2 or 4b1) of the connected sipe 4 of the other row, which is an adjacent row adjacent to the one row in the second predetermined direction, are arranged alternately in the tire circumferential direction. This allows for a higher density of the connected sipes 4, which is more effective in removing water film, and also balances the size of the land portion defined by the side portions. Furthermore, as in this example, the side portion (4b1 or 4b2) of one row of the connected sipe 4 and the side portion (4b2 or 4b1) of the adjacent row of the connected sipe 4 adjacent to the one row in the second predetermined direction are preferably arranged so that they overlap each other when projected in the tire circumferential direction. This allows for a much higher density of the connected sipes 4, which is more effective in removing water film.

Note, that in this example, the first side portion 4b1 and the second side portion 4b2 are inclined in the same direction in the tire circumferential direction and extend in the tire width direction, and the connected sipes 4 of the one row and the other row in the adjacent row are symmetrical about the axis along the tire width direction (vertically symmetrical in the figure), so that when the above arrangement is used, the size of the land portion to be defined can be made uniform.

Furthermore, in this embodiment, as illustrated in FIG. 1, only one end e1 of the main portion 4a terminates within the land portion 3. In addition, the ends e1 terminating within the land portion 3 are arranged alternately (on one side and the other side in the tire circumferential direction) between two rows adjacent to each other in the second predetermined direction, such that one end 4a in the first predetermined direction of the main portion 4a of the connecting sipe 4 of one row terminates within the land portion 3, and the other end (opposite side) in the first predetermined direction of the main portion 4a of the connected sipe 4 of the other row, which is an adjacent row adjacent to the one row in the second predetermined direction, terminates within the land portion. This can improve on-ice performance by balancing the locations where rigidity reduction is controlled and avoiding localized areas where the rigidity is reduced.

Each of the above effects should be obtained at each land portion, and therefore, it is preferable that all land portions 3 (regardless of whether these are block-shaped land portions or rib-shaped land portions) have the above connected sipes 4.

The connected sipes 4 can be arranged side by side in the tire circumferential direction within a row, except when the main portion 4b1 extends continuously in the circumferential direction. In such a case, as illustrated in FIG. 1, it is preferable to dispose one connected sipe 4 in each block (or block-shaped land portion defined by the width-directional sipes 6) for each row. This is because the high density of the connected sipes 4 can further increase the effectiveness of water film removal.

As illustrated in FIG. 1, each land portion 3 has a plurality of sub-sipes 7 which are arranged apart from the sipes 4. In this example, the sub-sipe 7 consists of a long side connected to a short side. The long side of the sub-sipe 7 has a configuration that is point symmetrical with the side portions 4b1 and 4b2 of the connected sipe 4, and the short side of the sub-sipe 7 has a configuration that is point symmetrical with the main portion 4a of the connected sipe 4. The long side of the sub-sipe 7 extends in the tire width direction or at an angle with respect to the tire width direction, and the short side of the sub-sipe 7 extends in the tire circumferential direction. The sub-sipes 7, a portion of the main portion 4a, and the side portions 4b1 (4b2) of the connected sipes 4 are arranged to face each other while being offset in the tire width direction, forming a pair of counter sipes. This allows for even higher density of sipes. In this example, the angle between the long and short sides of the sub-sipe 7 is obtuse. The ratio of the extension length of the long side to the extension length of the short side is preferably between 1 and 15. If the ratio is 15 or less to ensure the length of the short side, the effect of guiding drainage can be sufficient. On the other hand, if the ratio is 1 or more to keep the length of the short side reasonably short, the sipes can be arranged at a high density. As illustrated in the figure, the sub-sipes 7 are arranged in the tire circumferential direction (e.g., at equal intervals), and their short sides lie on the same straight line. The ratio of the length of the counter sipes along the tire circumferential direction to the length of the counter sipes along the tire width direction is preferably between 0.1 and 2.6. If the ratio is 0.1 or more, the distance between the sipes can be secured to ensure block rigidity, while if the ratio is 2.6 or less, q will not be excessive and the length in the width direction will not be too short, so the effect on the braking and driving force can be sufficient.

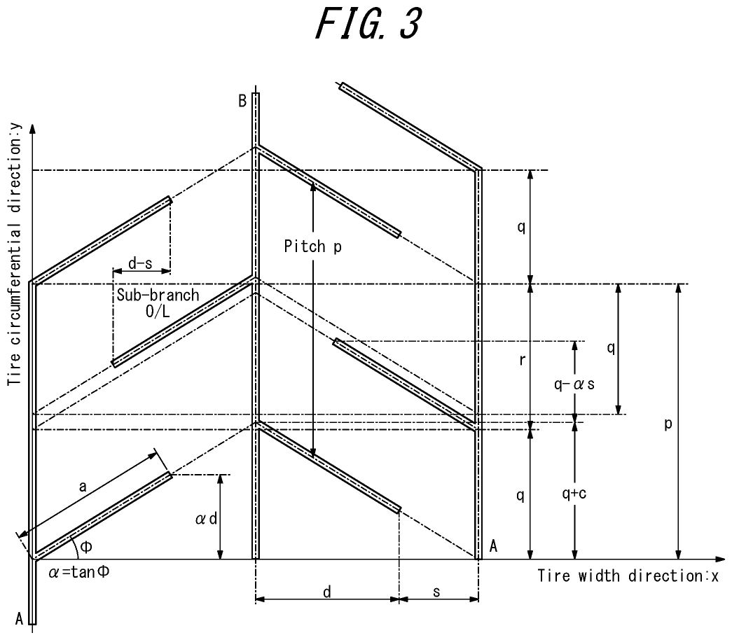

FIG. 3 illustrates the dimensions of the connected sipe 4.

As illustrated in FIG. 3, when the extension length of the side portions 4b1 and 4b2 of the connected sipe 4 is a (mm), the length in the tire width direction (projected length in the tire width direction) of the side portions 4b1 and 4b2 is d (mm), the distance between the end of the side portion 4b1 (4b2) of one of the connected sipes (the end terminating within the land portion) and the main portion 4a of the connected sipe adjacent to the one of the connected sipes is s (mm), and the inclination angle of the side portions 4b1 and 4b2 with respect to the tire width direction is φ, it can be expressed as: d=a×cos φ.

Here, s is preferably 1.5 (mm) or more, because a decrease in block rigidity can be further controlled by setting s to 1.5 (mm) or more. It is also preferable that d>s. This is because the side portions can be made to overlap each other when projected in the tire circumferential direction, thereby further increasing the effectiveness of removing water film by the sipe portion consisting of the side portions.

In addition, when the pitch in the circumferential direction between the side portions 4b1 (or 4b2) is p (mm), the clearance distances in the tire circumferential direction between the side portions 4b1 (4b2) of one connected sipe and the side portions 4b2 (4b1) of the connected sipe adjacent to the one connected sipe is q (mm) and r (mm) (q≤ r), it can be expressed as: p=q+r. Furthermore, the clearance distances in the tire circumferential direction c (mm) between the connection point of the main portion 4a and the branch portion 4b1 in one connected sipe and the connection point of the main portion 4a and the branch portion 4b2 in the connected sipe adjacent to the one connected sipe can be expressed as:

$$c = α ( d + s ) - q , α = tan φ ,$$

Here, when q=α×(d+s), c=0 and the circumferential positions of the branch points of adjacent sipe rows are aligned in the width direction. This ensures continuity in the sipe density of the branch portions with respect to the input in the tire width direction, reducing circumferential variation in block rigidity and providing stable lateral gripping performance. Therefore, a range of: q=α×(d+s)×0.8 to α×(d+s)×1.2 is desirable. In particular, when q=p/2, r=q, thus all the sipes in the sipe row are equally spaced in the tire circumferential direction. For this reason, q is preferably in the range of p/2×0.8 to p/2×1.2, and more preferably q is p/2. This allows for uniform sipe density in the tire circumferential direction in the block-shaped land portion.

### EXAMPLES

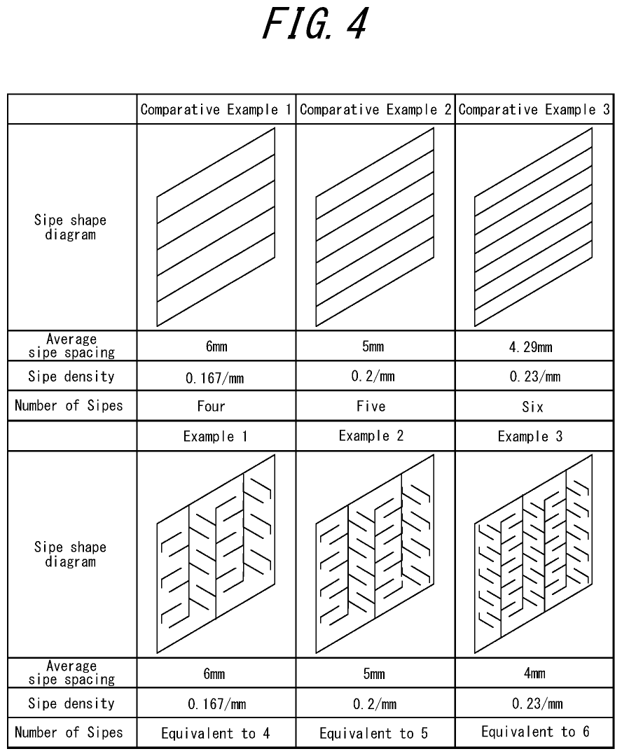

Examples are described below with reference to FIG. 4. FIG. 4 is a table providing Examples and Comparative Examples.

The Finite Element Method (FEM) simulations were performed on the tires of Examples 1 to 3 and Comparative Examples 1 to 3 provided in FIG. 4, and the block rigidity and ground contact area were evaluated under the condition of vertical load, which is obtained by multiplying the contact patch area of the block-shaped land portion at no load by the standard ground contact pressure of 230 kPa for passenger vehicle tires. In Examples 1 to 3 and Comparative Examples 1 to 3, the evaluation was performed as if the sipes illustrated in the sipe shape diagram in FIG. 4 were placed on the block-shaped land portions with a maximum length of 30 mm in the tire circumferential direction and a length of 27 mm in the tire width direction, respectively. All sipes had a width of 0.4 mm, a depth of 6.7 mm, and a tip R of 0.2 mm.

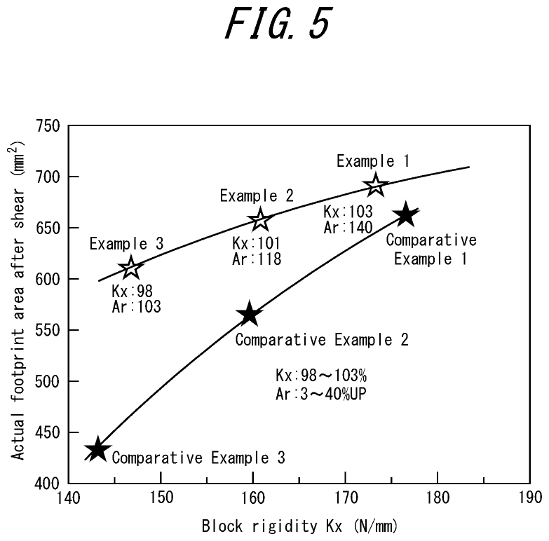

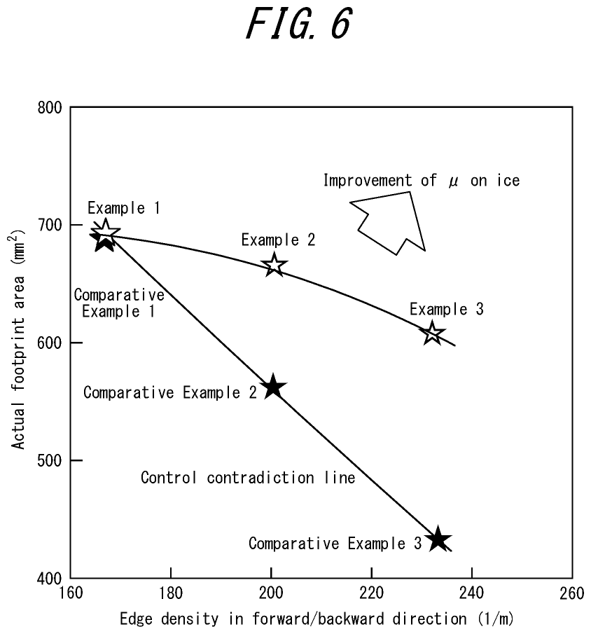

FIG. 5 provides the relationship between block rigidity and actual footprint area under shear. FIG. 6 provides the relationship between edge density and actual footprint area. Here, the block rigidity Kx (N/mm) is the shear input value in the tire circumferential direction when the lateral displacement in the same direction is 1 mm, and the actual footprint area under shear Ar (mm²) is the residual ground contact area with partial lifting when the shear input in the tire circumferential direction is 0.3 times the above vertical load. As provided in FIG. 5, it can be seen that Examples 1 to 3 are able to achieve both block rigidity and actual footprint area compared to Comparative Examples 1 to 3. As provided in FIG. 6, it can be seen that the actual footprint area increased for the same edge density in Examples 1 to 3 compared to Comparison Examples 1 to 3.

### REFERENCE SIGNS LIST

1 Tread surface
2 Circumferential main groove
3 Land portion
4 Connected sipe
Width direction groove
6 Width directional sipe
7 Sub-sipe
8 Width directional sipe
CL Tire equatorial plane
TE Tread edge

1. A pneumatic tire having at least one land portion in a tread surface, wherein
one or more connected sipes are disposed on at least one of the land portions,
the connected sipes have a main portion extending in a first predetermined direction and a side portion extending from the main portion to a side of the main portion at an angle with respect to the first predetermined direction and terminating within the land portion,
the side portion has a first side portion disposed on one side of the main portion and a second side portion disposed on the other side of the main portion, and
the first side portion and the second side portion are arranged alternately in the tire circumferential direction.

2. The pneumatic tire according to claim 1, wherein at least one end of the main portion terminates within the land portion.

3. The pneumatic tire according to claim 1, wherein the main portion extends in the tire circumferential direction, and
the side portion extends in the tire width direction or at an angle with respect to the tire width direction.

4. The pneumatic tire according to claim 1, having the land portion in which a plurality of rows of the connected sipes are arranged in a second predetermined direction.

5. The pneumatic tire according to claim 4, wherein two rows adjacent to each other in the second predetermined direction are arranged in a phase-shifted position in the tire circumferential direction, such that the side portion of the connected sipe of one row and the side portion of the connected sipe of the other row, which is an adjacent row adjacent to the one row in the second predetermined direction, are arranged alternately in the tire circumferential direction.

6. The pneumatic tire according to claim 4, wherein
only one end of the main portion terminates within the land portion, and
the ends terminating within the land portion are arranged alternately between two rows adjacent to each other in the second predetermined direction, such that one end in the first predetermined direction of the main portion of the connecting sipe of one row terminates within the land portion, and the other end in the first predetermined direction of the main portion of the connected sipe of the other row, which is an adjacent row adjacent to the one row in the second predetermined direction, terminates within the land portion.

7. The pneumatic tire according to claim 2, wherein the main portion extends in the tire circumferential direction, and
the side portion extends in the tire width direction or at an angle with respect to the tire width direction.

8. The pneumatic tire according to claim 2, having the land portion in which a plurality of rows of the connected sipes are arranged in a second predetermined direction.

9. The pneumatic tire according to claim 3, having the land portion in which a plurality of rows of the connected sipes are arranged in a second predetermined direction.

10. The pneumatic tire according to claim 7, having the land portion in which a plurality of rows of the connected sipes are arranged in a second predetermined direction.

11. The pneumatic tire according to claim 8, wherein two rows adjacent to each other in the second predetermined direction are arranged in a phase-shifted position in the tire circumferential direction, such that the side portion of the connected sipe of one row and the side portion of the connected sipe of the other row, which is an adjacent row adjacent to the one row in the second predetermined direction, are arranged alternately in the tire circumferential direction.

12. The pneumatic tire according to claim 9, wherein two rows adjacent to each other in the second predetermined direction are arranged in a phase-shifted position in the tire circumferential direction, such that the side portion of the connected sipe of one row and the side portion of the connected sipe of the other row, which is an adjacent row adjacent to the one row in the second predetermined direction, are arranged alternately in the tire circumferential direction.

13. The pneumatic tire according to claim 10, wherein two rows adjacent to each other in the second predetermined direction are arranged in a phase-shifted position in the tire circumferential direction, such that the side portion of the connected sipe of one row and the side portion of the connected sipe of the other row, which is an adjacent row adjacent to the one row in the second predetermined direction, are arranged alternately in the tire circumferential direction.

14. The pneumatic tire according to claim 5, wherein
only one end of the main portion terminates within the land portion, and
the ends terminating within the land portion are arranged alternately between two rows adjacent to each other in the second predetermined direction, such that one end in the first predetermined direction of the main portion of the connecting sipe of one row terminates within the land portion, and the other end in the first predetermined direction of the main portion of the connected sipe of the other row, which is an adjacent row adjacent to the one row in the second predetermined direction, terminates within the land portion.

15. The pneumatic tire according to claim 8, wherein
only one end of the main portion terminates within the land portion, and
the ends terminating within the land portion are arranged alternately between two rows adjacent to each other in the second predetermined direction, such that one end in the first predetermined direction of the main portion of the connecting sipe of one row terminates within the land portion, and the other end in the first predetermined direction of the main portion of the connected sipe of the other row, which is an adjacent row adjacent to the one row in the second predetermined direction, terminates within the land portion.

16. The pneumatic tire according to claim 9, wherein
only one end of the main portion terminates within the land portion, and
the ends terminating within the land portion are arranged alternately between two rows adjacent to each other in the second predetermined direction, such that one end in the first predetermined direction of the main portion of the connecting sipe of one row terminates within the land portion, and the other end in the first predetermined direction of the main portion of the connected sipe of the other row, which is an adjacent row adjacent to the one row in the second predetermined direction, terminates within the land portion.

17. The pneumatic tire according to claim 10, wherein
only one end of the main portion terminates within the land portion, and
the ends terminating within the land portion are arranged alternately between two rows adjacent to each other in the second predetermined direction, such that one end in the first predetermined direction of the main portion of the connecting sipe of one row terminates within the land portion, and the other end in the first predetermined direction of the main portion of the connected sipe of the other row, which is an adjacent row adjacent to the one row in the second predetermined direction, terminates within the land portion.

18. The pneumatic tire according to claim 11, wherein
only one end of the main portion terminates within the land portion, and
the ends terminating within the land portion are arranged alternately between two rows adjacent to each other in the second predetermined direction, such that one end in the first predetermined direction of the main portion of the connecting sipe of one row terminates within the land portion, and the other end in the first predetermined direction of the main portion of the connected sipe of the other row, which is an adjacent row adjacent to the one row in the second predetermined direction, terminates within the land portion.

19. The pneumatic tire according to claim 12, wherein
only one end of the main portion terminates within the land portion, and
the ends terminating within the land portion are arranged alternately between two rows adjacent to each other in the second predetermined direction, such that one end in the first predetermined direction of the main portion of the connecting sipe of one row terminates within the land portion, and the other end in the first predetermined direction of the main portion of the connected sipe of the other row, which is an adjacent row adjacent to the one row in the second predetermined direction, terminates within the land portion.

20. The pneumatic tire according to claim 13, wherein
only one end of the main portion terminates within the land portion, and
the ends terminating within the land portion are arranged alternately between two rows adjacent to each other in the second predetermined direction, such that one end in the first predetermined direction of the main portion of the connecting sipe of one row terminates within the land portion, and the other end in the first predetermined direction of the main portion of the connected sipe of the other row, which is an adjacent row adjacent to the one row in the second predetermined direction, terminates within the land portion.
